(19) United States
(12) Patent Application Publication
(10) Pub. No.: US 2023/0117241 A1
(43) Pub. Date: Apr. 20, 2023

(54) CHARGING CIRCUITRY WITH THREE-LEVEL CONVERTER AND METHOD FOR CONTROLLING BALANCING IN THE SAME

(71) Applicant: Samsung Electronics Co., Ltd., Suwon-si (KR)

(72) Inventor: Hangseok CHOI, Suwon-si (KR)

(21) Appl. No.: 17/968,144

(22) Filed: Oct. 18, 2022

Related U.S. Application Data
(63) Continuation of application No. PCT/KR2022/015628, filed on Oct. 14, 2022.

(30) Foreign Application Priority Data
Oct. 14, 2021 (KR) 10-2021-0136906

(51) Int. Cl. H02J 7/00; H02M 3/158; H02M 1/00; H02M 1/08

(52) U.S. Cl. CPC H02J 7/0019; H02J 7/0016; H02J 7/0068; H02M 3/1582; H02M 1/0095; H02M 1/08; H02M 1/008; H02J 2207/20; H02J 2207/40; H02J 50/00

(57) ABSTRACT

A charging circuit of an electronic device having a three-level converter, and a method and a device for controlling balancing in a charging circuit are provided. The electronic device includes a battery, at least one processor, and a charging circuit. The charging circuit includes, as a three-level converter, a switching circuit including multiple switching elements and a flying capacitor, and a filter circuit including an inductor and a capacitor. The charging circuit includes, as a balancing circuit, a balancing control circuit configured to, during balancing corresponding to a designated a mode, based on whether the balancing corresponds to targeted balancing, generate an output for maintaining or switching a balancing control direction configured for the designated mode, and a switching control circuit configured to perform switching for the switching elements in a balancing control direction corresponding to the designated mode, based on an output of the balancing control circuit, or perform switching for the switching elements in a direction reverse to a balancing control direction corresponding to the designated mode.

### CROSS-REFERENCE TO RELATED APPLICATION(S)

This application is a continuation application, claiming priority under § 365(c), of an International application No. PCT/KR2022/015628, filed on Oct. 14, 2022, which is based on and claims the benefit of a Korean patent application number 10-2021-0136906, filed on Oct. 14, 2021, in the Korean Intellectual Property Office, the disclosure of which is incorporated by reference herein in its entirety.

### TECHNICAL FIELD

The disclosure relates to a charging circuit of an electronic device having a three-level converter, and a method and a device for controlling balancing in a charging circuit.

### BACKGROUND ART

A charging circuit (charging circuitry) of an electronic device is designed to include a three-level converter in replacement of a two-level converter. For example, in the charging circuit, the three-level converter can maintain the same ripple current as that of a two-level converter using a large capacity inductor even when using an inductor having a relatively small capacity compared to a general two-level converter. Therefore, a three-level converter has an advantage of obtaining a high level of power conversion efficiency through reduction in the resistance of an inductor due to inductor capacity reduction, and has been applied to a charging circuit of an electronic device.

Generally, a charging circuit used in an electronic device may control the duty cycles of multiple switching elements (or switches) (e.g., MOSFET) (e.g., Q1, Q2, Q3, and Q4) of a three-level converter. For example, when a charging source supplies available power or higher to an output terminal, the charging circuit may reduce output power to prevent drop in input voltage, thereby determining the output power preventing the input voltage from falling to a designated value or smaller.

In addition, a charging circuit of a recent electronic device may include both a wired charging path and a wireless charging path. For example, the electronic device may provide output to an external device through a wired charging path, and provide power through a wireless charging path as an input to the electronic device. For example, the electronic device may support power to a different external device (e.g., on-the-go (OTG) device) while performing wireless charging with an external device, or may supply power to a wireless charging terminal via a wireless power sharing (power share) function (or a wireless battery sharing mode) of the electronic device while charging the electronic device by wire. When the power demanded by a power receiver is smaller than the power of a power supplier, the difference between two powers may be supplied to the output of the charging circuit. On the contrary, the power demanded by a power receiver is greater than the power of the power supplier, the charging circuit may operate as reverse boost, and the difference between two powers may be supplied from a battery of the electronic device.

In the environment described above, a three-level converter of the charging circuit is required to switch between a buck mode (or a buck operation) and a boost mode (or a boost operation) without disconnection of input power (with seamless transition). For example, in the charging circuit, in the buck mode of the three-level converter, a flying capacitor of the three-level converter may be charged while a first switching element (e.g., Q1 switch) is turned on, and the flying capacitor of the three-level converter may be discharged while a second switching element (e.g., Q2 switch) is turned on. As another example, in the charging circuit, in the boost mode of the three-level converter, the flying capacitor of the three-level converter may be discharged while the first switching element (e.g., Q1 switch) is turned on, and the flying capacitor of the three-level converter may be charged while the second switching element (e.g., Q2 switch) is turned on.

Therefore, a control direction of a balancing circuit for voltage balancing of the flying capacitor of the three-level converter in the charging circuit is required to be automatically switched according to an operation (e.g., the buck mode or the boost mode) of the charging circuit. For example, in a case of a charging circuit using the three-level converter, the time for which current flows through the first switching element (e.g., Q1 switch) is ideally the same as that of the second switching element (e.g., Q2 switch), and thus the voltage of the flying capacitor may be maintained at ½ of an input voltage.

However, a real charging circuit may have a fine difference in the current flow time due to the deviation of the circuit, and accordingly, the voltage of the flying capacitor may not be maintained at ½ of an input voltage. Therefore, the charging circuit may require a balancing circuit which is able to monitor the voltage of the flying capacitor and compensate for the current flow times of the first switching element (e.g., Q1 switch) and the second switching element (e.g., Q2 switch) so as to maintain the voltage of the flying capacitor at ½ of an input voltage.

For example, in a case of a buck mode operation, when the current flow time of the first switching element (e.g., Q1 switch) is increased, and the current flow time of the second switching element (e.g., Q2 switch) is decreased, the voltage of the flying capacitor may be increased. In a case of a boost mode operation, when the current flow time of the first switching element (e.g., Q1 switch) is increased, and the current flow time of the second switching element (e.g., Q2 switch) is decreased, the voltage of the flying capacitor may be reduced.

In order to implement the above description, a charging circuit is required to correctly determine whether the average of the inductor current of the three-level converter is negative or positive. For example, it is necessary for the charging circuit to additionally include a separate current sensing circuit for sensing inductor current. In addition, even when the charging circuit includes a current sensing circuit, it may be difficult to implement precise sensing (e.g., zero crossing detection) of inductor current due to the offset of the current sensing circuit. Therefore, a charging circuit implemented using a conventional three-level converter is unable to provide seamless switching between a buck mode and a boost mode. For example, balancing control for a flying capacitor of a three-level converter may be difficult in a dual-input charging circuit supporting both a wired charging path and a wireless charging path.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

Aspects of the disclosure are to address at least the above-mentioned problems and/or disadvantages and to provide at least the advantages described below. Accordingly, an aspect of the disclosure is to provide a method and a device for seamless switching between a buck mode and a boost mode in a charging circuit having a three-level converter.

Another aspect of the disclosure is to provide a charging circuit including a three-level converter and a balancing circuit for balancing control therefor, and a method and a device for conducting balancing so as to implement seamless switching between a buck mode and a boost mode in a charging circuit.

Another aspect of the disclosure is to provide a method and a device for adaptive balancing of a flying capacitor of a three-level converter in a charging circuit having the three-level converter.

Another aspect of the disclosure is to provide a method and device by which a balancing circuit for balancing of a flying capacitor may be implemented in a charging circuit having a three-level converter without sensing of inductor current.

Additional aspects will be set forth in part in the description which follows and, in part, will be apparent from the description, or may be learned by practice of the presented embodiments.

### Solution to Problem

In accordance with an aspect of the disclosure, an electronic device is provided. The electronic device includes a battery at least one processor and a charging circuit, wherein the charging circuit includes a three-level converter and a balancing circuit, wherein the three-level converter has one end connecting a charging path with at least one external device, and a remaining end connecting a charging path with the battery, is configured to perform a bi-directional operation including input and/or output related to a charging operation with the at least one external device, and includes a switching circuit including multiple switching elements and a flying capacitor, and a filter circuit including an inductor and a capacitor, and wherein the balancing circuit is configured to perform balance voltage of the flying capacitor of the three-level converter, and includes a balancing control circuit configured to, during balancing corresponding to a mode designated by the at least one processor as an initial operation mode, based on whether the balancing corresponds to targeted balancing, generate an output for maintaining or switching a balancing control direction configured for the designated mode, and a switching control circuit configured to perform switching for the switching elements in a balancing control direction corresponding to the designated mode, based on an output of the balancing control circuit, or perform switching for the switching elements in a direction reverse to a balancing control direction corresponding to the designated mode.

In accordance with another aspect of the disclosure, a charging circuit of an electronic device is provided. The charging circuit includes a three-level converter and a balancing circuit, wherein the three-level converter has one end connecting a charging path with at least one external device, and a remaining end connecting a charging path with the battery, is configured to perform a bi-directional operation including input and/or output related to a charging operation with the at least one external device, and includes a switching circuit including multiple switching elements and a flying capacitor, and a filter circuit including an inductor and a capacitor, wherein the balancing circuit is configured to balance voltage of the flying capacitor of the three-level converter, and includes a balancing control circuit configured to, during balancing corresponding to a designated mode, based on whether the balancing corresponds to targeted balancing, generate a first control signal for maintaining a first path configured for the designated mode, or a second control signal for switching the first path configured for the designated mode to a second path, and a switching control circuit configured to perform switching for the switching elements in a balancing control direction corresponding to the designated mode, based on input of the first control signal, or perform switching for the switching elements in a direction reverse to a balancing control direction corresponding to the designated mode, based on input of the second control signal, and wherein the second control signal indicates a signal obtained by reversing the first control signal.

In accordance with another aspect of the disclosure, an operation method of an electronic device is provided. The operation method includes performing balancing in a complex operation condition related to wired and wireless charging with at least one external device, based on a mode determined according to a basic configuration, while performing the balancing, checking a balancing state to determine whether the balancing corresponds to targeted balancing, when the balancing corresponds to targeted balancing, generating a first control signal to maintain a balancing control direction corresponding to the balancing, when the balancing does not correspond to targeted balancing, generating a second control signal obtained by reversing the first control signal, so as to reverse a balancing control direction corresponding to the balancing, performing selective switching for at least some of multiple switching elements so as to switch the determined mode corresponding to the basic configuration, and performing balancing of a flying capacitor in the switched mode.

### Advantageous Effects of Invention

According to an electronic device and an operation method thereof in the disclosure, in a charging circuit having a three-level converter, seamless switching between a buck mode (or buck opinion) and a boost mode (or boost operation) of the three-level converter may be implemented via a balancing circuit (e.g., an automatic balancing operation switching circuit) for balancing of a flying capacitor. According to various embodiments, in an environment of input and output bi-directional operation for charging such as OTG device charging and wireless charging or universal serial bus (USB) wired charging and wireless power sharing, even when the power of an external power source is insufficient, a buck mode and a boost mode may be naturally and seamlessly switched therebetween.

According to various embodiments, in a charging circuit capable of a bi-directional operation using a three-level converter, an automatic selection may be possible regardless of a designated balancing mode for the voltage of a flying capacitor. For example, according to the disclosure, an electronic device may switch between a buck mode and a boost mode without disconnection of the input power of a charging circuit in a complex operation condition in which wired charging and wireless charging are performed together. Therefore, the charging circuit may determine whether a currently configured control direction of a balancing circuit is proper, by using only a range of the flying capacitor without sensing of inductor current.

According to various embodiments, when a control direction of a balancing circuit is wrong, a charging circuit may adaptively change (change a current charging path) the control direction of the balancing circuit, and perform accurate balancing (e.g., step-down or step-up) according to the changed control direction.

Various other effects directly or indirectly recognized herein can also be provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram illustrating an example electronic device in a network environment according to an embodiment of the disclosure;

FIG. 2 is a diagram illustrating an electronic device and an external device to explain a charging operation of the electronic device according to an embodiment of the disclosure;

FIG. 3 is a diagram illustrating an example of a circuit configuration of a three-level converter with regard to FIG. 2 according to an embodiment of the disclosure;

FIG. 4 is a diagram illustrating an example in a three-level converter with regard to FIG. 2 being operated in a buck mode according to an embodiment of the disclosure;

FIG. 5 is a diagram illustrating an example in a three-level converter with regard to FIG. 2 being operated in a boost mode according to an embodiment of the disclosure;

FIG. 6 is a diagram illustrating an example of a circuit configuration of a balancing control circuit in a balancing circuit with regard to FIG. 2 according to an embodiment of the disclosure;

FIGS. 7A and 7B are diagrams illustrating an example of a circuit configuration and an operation of a switching control circuit in a balancing circuit with regard to FIG. 2 according to various embodiments of the disclosure;

FIGS. 8A and 8B are diagrams illustrating a balancing control operation of an electronic device according to various embodiments of the disclosure; and

FIG. 9 is a flowchart illustrating an operation method for supporting charging by an electronic device according to an embodiment of the disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

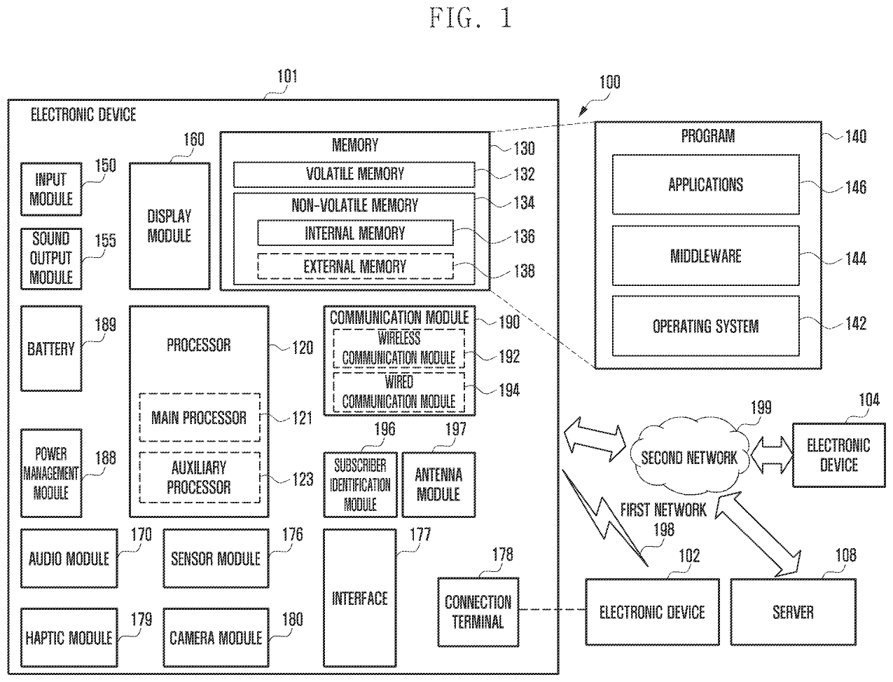

FIG. 1 is a block diagram illustrating an example electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

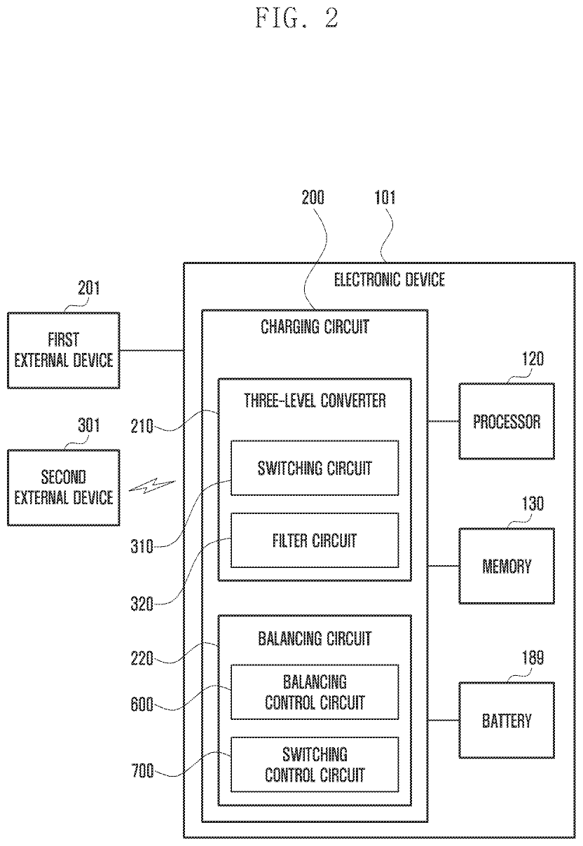

FIG. 2 is a diagram illustrating an electronic device and an external device to explain a charging operation of the electronic device according to an embodiment of the disclosure.

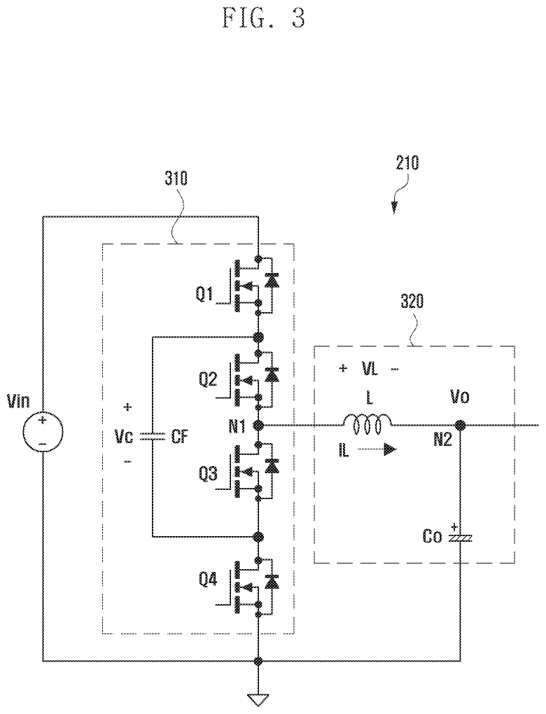

FIG. 3 is a diagram illustrating an example of a circuit configuration of a three-level converter with regard to FIG. 2 according to an embodiment of the disclosure.

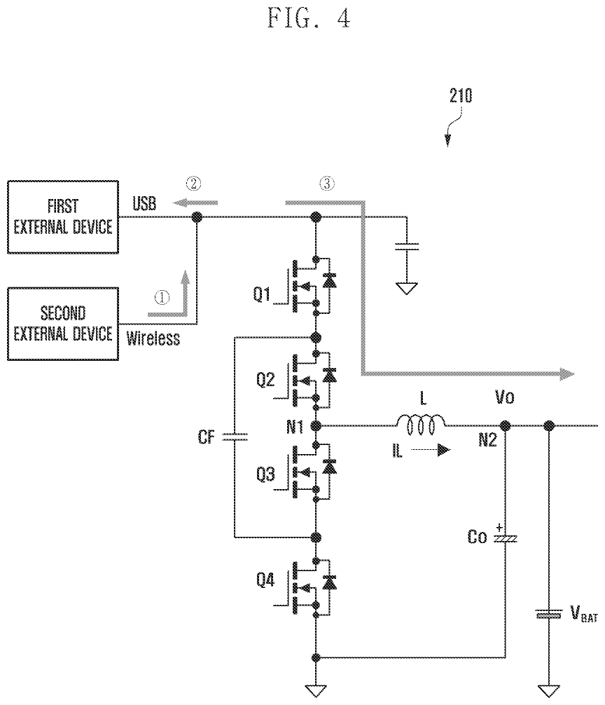

FIG. 4 is a diagram illustrating an example in a three-level converter with regard to FIG. 2 being operated in a buck mode according to an embodiment of the disclosure.

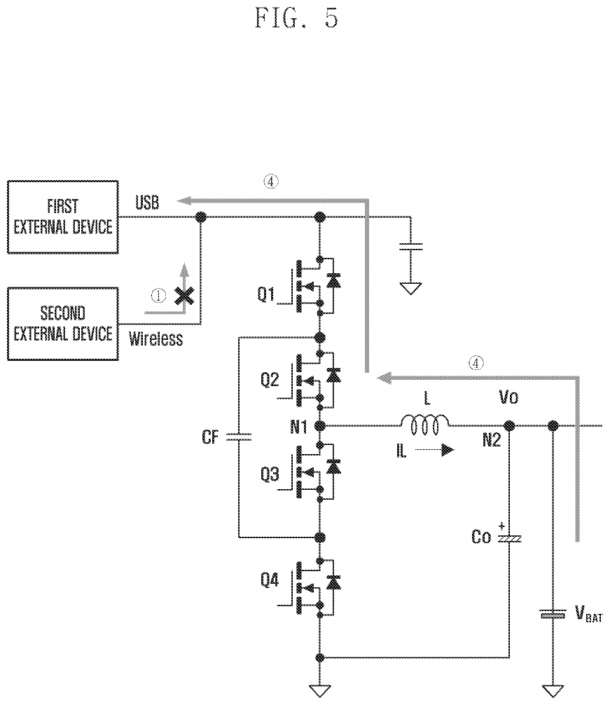

FIG. 5 is a diagram illustrating an example in a three-level converter with regard to FIG. 2 being operated in a boost mode according to an embodiment of the disclosure.

According to an embodiment, FIG. 2 may show an example of a configuration related to supply of a charging operation by the electronic device 101 and an external device (e.g., a first external device 201 and/or a second external device 301). According to another embodiment, the electronic device 101 and the external devices 201 and 301 illustrated in FIG. 2 as an example may include all or at least some of the elements of the electronic device 101 as described in the description given with reference to FIG. 1.

As illustrated in FIG. 2, the electronic device 101 according to an embodiment may be an electronic device that is able to simultaneously support input for internal charging and output for external charging. The electronic device 101 may include a device capable of a bi-directional charging operation. The electronic device 101 may include a smartphone, a tablet personal computer (PC), and/or a laptop computer which are able to perform a bi-directional charging operation. The electronic device 101 according to an embodiment of the disclosure is not limited to the devices described above, and the electronic device 101 may be various types of devices which include the battery 189 and are capable of a bi-directional charging operation.

According to yet another embodiment, when the first external device 201 is an on-the-go (OTG) device, the electronic device 101 may supply power of the battery 189 of the electronic device 101 to the first external device 201 so as to charge the first external device 201. According to an embodiment, when the first external device 201 is a universal serial bus (USB) charger, the electronic device 101 may receive power from the first external device 201 so as to charge the battery 189 of the electronic device 101.

According to another embodiment, the electronic device 101 may wirelessly receive power from the second external device 301 so as to charge the battery 189 of the electronic device 101. According to yet another embodiment, the electronic device 101 may wirelessly transmit power to the second external device 301 so as to support charging of the second external device 301.

According to an embodiment, while being connected to the first external device 201 and performing a charging operation with the first external device 201, the electronic device 101 may transmit or receive wireless power to or from the second external device 301 according to a wireless charging mode (e.g., a wireless power transmission mode or a wireless power reception mode).

The first external device 201 according to an embodiment is a device (e.g., OTG device) capable of being connected by wire (e.g., USB OTG connection) to the electronic device 101, and may exchange data with the electronic device 101 via direct communication, and charge a battery (not illustrated) in the first external device 201, based on the voltage supplied from the electronic device 101 when being connected to the electronic device 101. The first external device 201 may include a wearable device, such as a watch (e.g., smart watch), earphones, a headset, and/or glasses (e.g., AR glasses). According to another embodiment, the first external device 201 may include a USB charger that is connected by wire (e.g., USB connection) to the electronic device 101, and provides power to the electronic device 101 via direct communication.

The second external device 301 according to yet an embodiment may include a device that wirelessly transmits power to the electronic device 101 so as to support wireless charging of the electronic device 101, or wirelessly receive power from the electronic device 101 so as to support charging of a battery (not illustrated) of the second external device 301. The second external device 301 may include various types of devices such as a smartphone, a tablet PC, and/or a charging pad.

The second external device 301 according to an embodiment of the disclosure is not limited to the devices described above, and the second external device 301 may be various types of devices which are able to transmit and/or receive wireless power. According to another embodiment, the second external device 301 may wirelessly transmit or receive power to or from the electronic device 101, and the electronic device 101 may wirelessly receive or transmit power from or to the second external device 201.

Referring to FIG. 2, the electronic device 101 illustrated in FIG. 2 may include an example of a charging circuit 200 for explanation of a charging operation according to an embodiment of the disclosure. The electronic device 101 may include the processor 120, the memory 130, the battery 189, and the charging circuit 200.

In an embodiment, when the electronic device 101 is connected to the first external device 201, in a case where the first external device 201 is an OTG device, the processor 120 may operate to supply power of the battery 189 of the electronic device 101 so as to charge the first external device 201. In another embodiment, when the electronic device 101 is connected to the first external device 201, in a case where the first external device 201 is a USB charger, the processor 120 may operate to receive power from the first external device 201 so as to charge the battery 189 of the electronic device 101. According to yet another embodiment, when the first external device 201 is an OTG device, the processor 120 may control data communication (e.g., audio data transmission or reception) with the first external device 201.

According to an embodiment, the processor 120 may operate to wirelessly receive power from the second external device 301 so as to charge the battery 189 of the electronic device 101, or to wirelessly transmit power to the second external device 301 so as to support charging of the second external device 301. According to another embodiment, while being connected to the first external device 201 and performing a charging operation with the first external device 201, the processor 120 may transmit or receive wireless power to or from the second external device 301 according to a wireless charging mode (e.g., a wireless power transmission mode or a wireless power reception mode).

According to yet another embodiment, when performing a charging function, the processor 120 may configure an initial operation mode (e.g., a boost mode or a buck mode) of a balancing circuit 220 in the charging circuit 200, and the balancing circuit 220 may operate based on the initial operation mode configured by the processor 120.

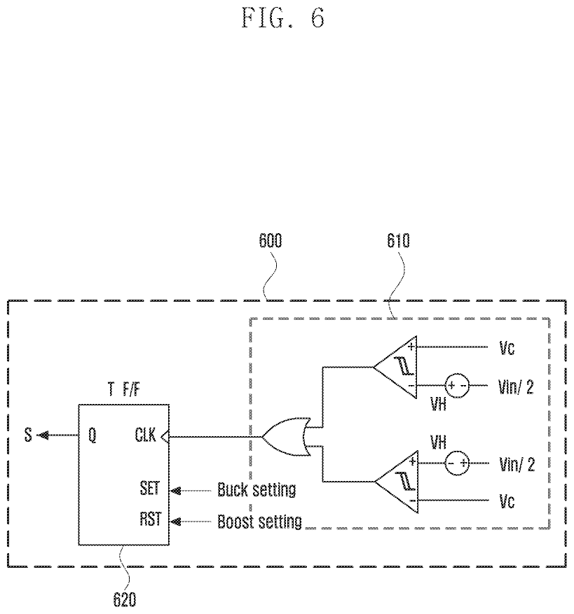

The processor 120 may determine the output of a balancing control circuit 600 (e.g., a toggle circuit 620 in FIG. 6) of the balancing circuit 220 at an initial operation of the charging circuit 200 by using a value (e.g., set or reset) depending on an initial operation mode configuration. The processor 120 may determine a first configuration value for operation of the charging circuit 200 in a boost mode when a first charging function and/or a second charging function is performed, and determine a second configuration value for operation of the charging circuit 200 in a buck mode when a third charging function and/or a fourth charging function is performed.

In an embodiment, the buck mode may indicate a mode (e.g., a step-down mode) of decreasing an input voltage and outputting the decreased input voltage. In another embodiment, the boost mode may indicate a mode (e.g., a step-up mode) of increasing an input voltage and outputting the increased input voltage. According to yet another embodiment, the processor 120 may determine an operation mode of a three-level converter 210, based on a medium voltage (or center value), and control the balancing circuit 220 to operate the three-level converter 210, based on the medium voltage and the operation mode.

In an embodiment, the first charging function may include, for example, a function of charging the first external device 201 (e.g., OTG device) with power of the battery 189 of the electronic device 101 and/or the second external device 301 in the buck mode.

In another embodiment, the second charging function may include, for example, a function (e.g., a wireless battery sharing mode) of wirelessly charging the second external device 301 (e.g., another electronic device) with power of the battery 189 of the electronic device 101.

In yet another embodiment, the third charging function may include, for example, a function of charging the battery 189 of the electronic device 101 with power wirelessly received from the second external device 301 (e.g., another electronic device or charging pad).

In an embodiment, the fourth charging function may include, for example, a function of charging the battery 189 of the electronic device 101 with power received by wire from the first external device 201 (e.g., USB charger).

In another embodiment, the memory 130 may include the functions of the memory 130 as described in the description given with reference to FIG. 1. According to yet another embodiment, the memory 130 may store various data related to a charging operation of the electronic device 101. According to an embodiment, the data may include an initial operation mode configuration value depending on the first charging function, the second charging function, the third charging function, and/or the fourth charging function when a charging function of the electronic device 101 is performed.

In another embodiment, the battery 189 may supply power to at least one element of the electronic device 101. According to yet another embodiment, the battery 189 may be charged by being supplied from the charging circuit 200 with at least a part of power received from the first external device 201 or the second external device 301. According to an embodiment, the battery 189 may directly or wirelessly supply power to the first external device 201 or the second external device 301 via the charging circuit 200, so as to support charging of the first external device 201 or the second external device 301.

According to another embodiment, the battery 189 may include a battery protection circuit (e.g., a protection circuit module (PCM)). The battery protection circuit may perform various functions (e.g., a pre-cutoff function) for prevention performance degradation of or damage to the battery 189. The battery protection circuit may be additionally or alternatively configured as at least a part of a battery management system (BMS) for cell balancing, measurement of capacity, the number of times of charging/discharging, the temperature, or the voltage of the battery.

In yet another embodiment, the charging circuit 200 may include the three-level converter 210 and the balancing circuit (balancing circuitry) 220.

In an embodiment, one end of the three-level converter 210 may be connected through a charging path to at least one external device (e.g., the first external device 201 and/or the second external device 301 in FIG. 2) via the charging circuit 200, and the other end thereof may be connected through a charging path to the battery 189 of the electronic device 101. In another embodiment, the three-level converter 210 may support a bi-directional operation including input and/or output related to a charging operation with at least one external device.

In yet another embodiment, the three-level converter 210 of the charging circuit 200 may include a switching circuit 310 and a filter circuit 320. An example of a structure of the three-level converter 210 according to an embodiment is illustrated in FIG. 3.

Referring to FIG. 3, according to an embodiment, the switching circuit 310 may perform switching control of an input voltage Vin. The switching circuit 310 may include multiple switching elements including a first switching element Q1, a second switching element Q2, a third switching element Q3, and a fourth switching element Q4, and a flying capacitor CF.

In an embodiment, each of the multiple switching elements may use a transistor (e.g., metal-oxide-semiconductor field-effect transistor (MOSFET)). In another embodiment, signals (e.g., gate drive signals) for control switching may be applied to a gate drive of the first switching element Q1, a gate drive of the second switching element Q2, a gate drive of the third switching element Q3, and a gate drive of the fourth switching element Q4. A pulse width modulation (PWM) signal may be input to each of the gate drives of the multiple switching elements Q1, Q2, Q3, and Q4 so as to control switching.

In yet another embodiment, the switching elements Q1, Q2, Q3, and Q4 may include, for example, source, gate, and drain terminals, and the switching elements Q1, Q2, Q3, and Q4 may be turned on/off, based on on/off of gate voltage. The gates of the switching elements Q1, Q2, Q3, and Q4 may be similar to a kind of capacitor, and the switching elements Q1, Q2, Q3, and Q4 may be operated according to a principle of filling or emptying the capacitor to turn on/off the switching elements.

The gate and the drain or source of the switching elements Q1, Q2, Q3, and Q4 may not have electrical connection therebetween, and may be separated from each other. When a voltage (e.g., a threshold voltage) having a predesignated value or greater is applied to the gate of the switching elements Q1, Q2, Q3, and Q4, a current may flow between the drain and the source. In an embodiment, the voltage (e.g., a threshold voltage) having the predesignated value or greater may vary, for example, between 2 V and 10 V. According to an embodiment, in the switching circuit 310, the third switching element Q3 may be a reversing circuit of the second switching element Q2, and the fourth switching element Q4 may be a reversing circuit of the first switching element Q1.

In another embodiment, the flying capacitor CF may indicate a capacitor used to increase voltage. A negative electrode of the flying capacitor CF may not be attached to the ground, and both ends thereof may be connected to a switching element.

According to yet another embodiment, the flying capacitor CF may be charged, discharged, or floated according to an operation of at least some switching elements among the multiple switching elements Q1, Q2, Q3, and Q4.

In an embodiment, the flying capacitor CF may be charged according to an operation of the first switching element Q1 and the third switching element Q3, and may be discharged according to an operation of the second switching element Q2 and the fourth switching element Q4. In another embodiment, the flying capacitor CF may be charged while the first switching element Q1 and the third switching element Q3 are turned on, and the second switching element Q2 and the fourth switching element Q4 are turned off. The output (e.g., the voltage of a switching node or the voltage of an input terminal of an inductor L) of the switching circuit 310 may be a half voltage (e.g., Vin−Vc=Vin/2) of an input voltage Vin.

As another example, the flying capacitor CF may be discharged while the first switching element Q1 and the third switching element Q3 are turned off, and the second switching element Q2 and the fourth switching element Q4 are turned on. The output of the switching circuit 310 may be a half voltage (e.g., Vc=Vin/2) of an input voltage Vin.

In yet another embodiment, the flying capacitor CF may be floated when the first switching element Q1 and the second switching element Q2 are simultaneously turned on, and the third switching element Q3 and the fourth switching element Q4 are simultaneously turned off. The output of the switching circuit 310 may be an input voltage Vin. In an embodiment, the flying capacitor CF may be floated when the first switching element Q1 and the second switching element Q2 are simultaneously turned off, and the third switching element Q3 and the fourth switching element Q4 are simultaneously turned on. The output of the switching circuit 310 may be 0.

In another embodiment, a short circuit (short) may occur when the first switching element Q1 and the fourth switching element Q4 are simultaneously turned on. Control signals for the first switching element Q1 and the fourth switching element Q4 may be inverse to each other. In an embodiment, a short circuit may occur when the second switching element Q2 and the third switching element Q3 are simultaneously turned on. Control signals for the second switching element Q2 and the third switching element Q3 may be inverse to each other.

The filter circuit 320 according to an embodiment may smooth an output signal of the switching circuit 310 so as to output an output voltage Vo. In yet another embodiment, the filter circuit 320 may include an inductor L and a capacitor Co. According to an embodiment, the filter circuit 320 may be configured to further include a resistor R.

In another embodiment, the inductor L may be charged with energy when a switching element is turned on, and may transfer (discharge) the energy to an output terminal while maintaining current inertia when a switching element is turned off.

In yet another embodiment, one end of the inductor L may be connected to the second switching element Q2 and the third switching element Q3 through a first contact point N1 between the second switching element Q2 and the third switching element Q3. The other end of the inductor L may be connected to one end of the capacitor Co at a second contact point N2. The other end of the capacitor Co may be connected to the ground. The voltage of the second contact point N2 may correspond to an output voltage of the filter circuit 320.

According to an embodiment, the filter circuit 320 may configure an LC filter (e.g., a low pass filter (LPF)) including the inductor L and the capacitor Co. The inductor L and the capacitor Co may remove a high-frequency component occurring at an output terminal, pass only a direct current component therethrough, and transfer same to the output terminal.

According to another embodiment, the three-level converter 210 including the above configuration may be a DC-DC converter that receives an input voltage Vin, and generates an output voltage Vo from the input voltage through a switching operation for charging the battery 189. In yet another embodiment, the meaning of “three-level” is related to the number of voltage levels used for the switching operation of the DC-DC converter, and for example, may indicate a converter that is operable at three levels such as an input voltage Vin, a half voltage Vin/2 of the input voltage Vin, and a zero voltage (0V).

Referring to an example illustrated in FIG. 3, when the first switching element Q1 and the second switching element Q2 among the switching elements (e.g., Q1, Q2, Q3, and Q4) are turned on, the voltage of a switching node may be an input voltage Vin, when the first switching element Q1 and the third switching element Q3, or the second switching element Q2 and the fourth switching element Q4 are turned on, the voltage of the switching node may be a half voltage Vin/2 of the input voltage Vin, and when the third switching element Q3 and the fourth switching element Q4 are turned on, the voltage of the switching node may be a zero voltage (0V). An example of such the three-level converter 210 is illustrated in FIG. 3, and the number of voltage levels of a DC-DC converter used in the disclosure is not limited thereto.

According to an embodiment, the three-level converter 210 may be a circuit that controls an output voltage Vo to be a target voltage lower than an input voltage Vin. An output voltage Vo may be represented by a multiplication of an input voltage Vin and a duty (D) (e.g., a switching duty) of the switching elements Q1, Q2, Q3, and Q4. The output voltage may be represented by Vo=D*Vin. The duty is a duty ratio and has a value between 0 and 1, and for example, when a switch is on, the duty may be “1”, when the switch is only half on, the duty may be “0.5”, and, when the switch is off, the duty may be “0”.

According to another embodiment, when the voltage Vc of the flying capacitor CF is maintained at a half (or ½) of an input voltage Vin, the first switching element Q1 and the second switching element Q2 of the three-level converter 210 may have the same duty cycle, and the phase difference between duty signals may be 180 degrees (or phase difference).

According to yet another embodiment, when the voltage Vc of the flying capacitor CF becomes smaller than ½ of an input voltage Vin, the three-level converter 210 may gradually increase the duty cycle of the first switching element Q1 and gradually reduce the duty cycle of the second switching element Q2 until the voltage Vc of the flying capacitor CF is restored to be ½ of the input voltage Vin.

According to an embodiment, when the voltage Vc of the flying capacitor CF becomes greater than ½ of an input voltage Vin, the three-level converter 210 may gradually reduce the duty cycle of the first switching element Q1 and gradually increase the duty cycle of the second switching element Q2 until the voltage Vc of the flying capacitor CF is reduced to be ½ of the input voltage Vin.

According to another embodiment, when the duty is 0.5 or smaller, a voltage VL applied to the inductor L of the three-level converter 210 may be switched from 0 to Vin/2, and when the duty is 0.5 or greater, the voltage VL applied to the inductor L may be switched from Vin/2 to an input voltage Vin. Therefore, the three-level converter 210 has an effect of reducing a voltage applied to the inductor L to the half of that of a general converter (e.g., a two-level converter). This may reduce the size of the ripple of an inductor current IL, and the ripple of an output voltage Vo. As described above, the three-level converter 210 may enable various operation modes based on various level combinations compared to a general two-level converter.

In addition, even when employing the inductor L having relatively small capacity compared to an inductor implemented in a two-level converter, the three-level converter 210 may maintain the same current ripple as that of the two-level converter using a large capacity. Therefore, a high power conversion efficiency may be obtained through reduction of resistance of the inductor L due to reduction of capacity of the inductor L.

According to yet another embodiment, the charging circuit 200 may include both a wired charging path and a wireless charging path. The charging circuit 200 may provide output to the first external device 201 through a wired charging path, and provide, as an input to the electronic device 101, power received from the second external device 301 through a wireless charging path. As another example, the charging circuit 200 may provide, as an input to the electronic device 101, power received from the first external device 201 through a wired charging path, and provide an output to the second external device 301 through a wireless charging path.

The electronic device 101 may supply power to a different external device (e.g., OTG device) while performing wireless charging with the second external device 301, or may supply power to a wireless charging terminal via a wireless power sharing (power share) function (or a wireless battery sharing mode) of the electronic device 101 while charging the electronic device 101 by wire.

When the power demanded by a power receiver is smaller than the power of a power supplier, the difference between two powers may be supplied to the output of the charging circuit 200. On the contrary, the power demanded by a power receiver is greater than the power of the power supplier, the charging circuit 200 may operate as reverse boost, and the difference between two powers may be supplied from the battery 189 of the electronic device 101.

In the environment described above, the three-level converter 210 of the charging circuit 200 is required to switch between a buck mode (or a buck operation) and a boost mode (or a boost operation) without disconnection of input power (with seamless transition). An example therefor is illustrated in FIGS. 4 and 5.

Referring to FIGS. 4 and 5, FIGS. 4 and 5 may show an example of the three-level converter 210 operating in a buck mode (FIG. 4) and an example of same operating in a boost mode (FIG. 5).

In an embodiment, FIG. 4 may show a state where the electronic device 101 is connected to the first external device 201 (e.g., OTG device) and performs data communication and/or charging, and at the same time, receives wireless power from the second external device 301 according to a wireless charging mode (e.g., a wireless power reception mode). The example illustrated in FIG. 4 may show a charging path according to a buck mode of the three-level converter 210.

In another embodiment, FIG. 5 may show a state where, in the state as in FIG. 4, the electronic device 101 is disconnected from the second external device 301, and reception of wireless power from the second external device 301 is stopped (or blocked). The example illustrated in FIG. 5 may show the flow of a charging path according to a boost mode of the three-level converter 210.

As illustrated in FIG. 4, when the electronic device 101 is connected to the first external device 201 and the second external device 301, and operates in a buck mode, the charging circuit 200 may configure a first charging path for transferring, to the first external device 201, at least partial voltage (\textcircled{2}) of an input voltage (\textcircled{1}) received from the second external device 301, and transferring, to the battery 189 of the electronic device 101, the remaining partial voltage (\textcircled{3}=\textcircled{1}−\textcircled{2}) of the input voltage (\textcircled{1}).

As illustrated in FIG. 5, when, in the state as in FIG. 4 (e.g., operating in the buck mode), the electronic device 101 operates in a boost mode switched from the buck mode, and is disconnected from the second external device 301, thus an input voltage (\textcircled{1}) from the second external device 301 is blocked, the charging circuit 200 may configure a second charging path for transferring, to the first external device 201, a voltage VBAT (\textcircled{4}) of the battery 189 of the electronic device 101. The charging circuit 200 may adaptively switch between a buck mode (or a buck operation) and a boost mode (or a boost operation) of the three-level converter 210.

According to an embodiment, in the three-level converter 210 (e.g., the switching circuit 310), in the buck mode, the flying capacitor CF may be charged while the first switching element Q1 is turned on, and the flying capacitor CF may be discharged while the second switching element Q2 is turned on. According to another embodiment, in the three-level converter 210 (e.g., the switching circuit 310), in the boost mode, the flying capacitor CF may be discharged while the first switching element Q1 is turned on, and the flying capacitor CF may be charged while the second switching element Q2 is turned on. Therefore, a control direction of a balancing circuit (balancing circuitry) for balancing the voltage of the flying capacitor CF of the three-level converter 210 in the charging circuit 200 is required to be automatically switched according to an operation (e.g., a buck mode or a boost mode) of the three-level converter 210.

In a case of the charging circuit 200 using the three-level converter 210, the time for which current flows through the first switching element Q1 is ideally the same as that of the second switching element Q2, and thus the voltage of the flying capacitor may be maintained at ½ of an input voltage. However, the real charging circuit 200 may have a fine difference in the current flow time due to the deviation of the circuit, and accordingly, the voltage of the flying capacitor CF may not be maintained at ½ of an input voltage.

Therefore, the charging circuit 200 may require a balancing circuit which is able to monitor the voltage of the flying capacitor CF, and compensate for the current flow times of the first switching element Q1 and the second switching element Q2 so as to maintain the voltage of the flying capacitor CF at ½ of an input voltage. In a case of a buck mode operation, when the current flow time of the first switching element Q1 is increased, and the current flow time of the second switching element Q2 is decreased, the voltage of the flying capacitor CF may be increased. In a case of a boost mode operation, when the current flow time of the first switching element Q1 is increased, and the current flow time of the second switching element Q2 is decreased, the voltage of the flying capacitor CF may be reduced.

The disclosure may provide the balancing circuit 220 which is able to determine (e.g., determine the propriety of current balancing, based on whether the current balancing corresponds to targeted balancing) a state of current balancing regardless of a designated balancing mode for the voltage of the flying capacitor CF of the three-level converter 210, and accordingly, support seamless switching between operations corresponding to a buck mode and a boost mode in the designated balancing mode for the three-level converter 210.

Referring to FIG. 2 again, the charging circuit 200 may include the balancing circuit 220 for controlling seamless switching between a buck mode and a boost mode for the three-level converter 210, as described above. The electronic device 101 or the charging circuit 200 of the electronic device 101 according to the disclosure may include the balancing circuit 220 for adaptive operation control for the three-level converter 210.

In an embodiment, the balancing circuit 220 may include a circuit for controlling balancing of the flying capacitor CF of the three-level converter 210. The balancing circuit 220 may generate a control signal (e.g., a gate drive signal or a duty signal) for balancing, based on a change in an output voltage Vo and/or an inductor current IL of both ends of the inductor L of the three-level converter 210, and output the control signal to the switching circuit 310 of the three-level converter 210. According to the control signal, at least some of the multiple switching elements Q1, Q2, Q3, and Q4 included in the switching circuit 310 of the three-level converter 210 may be selectively turned on so as to allow charging or discharging of the flying capacitor CF.

In another embodiment, the balancing circuit 220 may be a circuit for preventing the voltage of the flying capacitor CF from failing to be maintained at a half voltage Vin/2 of an input voltage Vin, and drifting. The balancing circuit 220 according to the disclosure may, in a complex operation condition related to wired and wireless charging of the electronic device 101, perform balancing according to a designated balancing mode, and identify whether the corresponding balancing corresponds to targeted balancing.

According to yet another embodiment, the balancing circuit 220 may, based on whether the corresponding balancing corresponds to targeted balancing, may maintain a first path configured in the current mode (e.g., a buck mode or a boost mode), or toggle (or reverse) the first path configured in the current mode to a second path opposite to the first path.

According to an embodiment, in the current mode and according to the first path, the balancing circuit 220 may operate to gradually increase the duty cycle of the first switching element Q1 and gradually reduce the duty cycle of the second switching element Q2 when the voltage Vc of the flying capacitor CF becomes smaller than ½ of an input voltage Vin, so as to restore the voltage Vc of the flying capacitor CF to be ½ of the input voltage Vin.

As another example, in the current mode and according to the first path, the balancing circuit 220 may operate to gradually reduce the duty cycle of the first switching element Q1 and gradually increase the duty cycle of the second switching element Q2 when the voltage Vc of the flying capacitor CF becomes greater than ½ of an input voltage Vin, so as to reduce the voltage Vc of the flying capacitor CF to be ½ of the input voltage Vin.

According to another embodiment, in the current mode and according to the second path, the balancing circuit 220 may operate to gradually reduce the duty cycle of the first switching element Q1 and gradually increase the duty cycle of the second switching element Q2 when the voltage Vc of the flying capacitor CF becomes smaller than ½ of an input voltage Vin, so as to restore the voltage Vc of the flying capacitor CF to be ½ of the input voltage Vin.

As another example, in the current mode and according to the second path, the balancing circuit 220 may operate to gradually increase the duty cycle of the first switching element Q1 and gradually reduce the duty cycle of the second switching element Q2 when the voltage Vc of the flying capacitor CF becomes greater than ½ of an input voltage Vin, so as to reduce the voltage Vc of the flying capacitor CF to be ½ of the input voltage Vin.

According to yet another embodiment, the balancing circuit 220 may determine whether current balancing is proper, regardless of a designated mode (e.g., a buck mode or a boost mode) for the voltage of the flying capacitor CF in the charging circuit 200 capable of a bi-directional operation using the three-level converter 210. The balancing circuit 220 may determine whether current balancing corresponds to targeted balancing (e.g., the voltage of the flying capacitor CF is maintained at a half voltage Vin/2 of an input voltage Vin). According to an embodiment, the balancing circuit 220 may automatically select and switch to a path corresponding to (suitable for) current balancing, based on a result of determination. The balancing circuit 220 according to the disclosure may support adaptive switching of a path for the current mode of the three-level converter 210 without disconnection of the input power of the charging circuit 200 in a complex operation condition in which the electronic device 101 performs wired and wireless charging.

In another embodiment, the complex operation condition may include, for example, various complex environments, such as detection of connection to the first external device 201 (e.g., OTG device) while the electronic device 101 performs a wireless charging function (e.g., a wireless power reception mode) with the second external device 301, detection of connection to and performing a wireless charging function (wireless power reception mode) with the second external device 301 during connection to the first external device 201 (e.g., OTG device), detection of performing a wireless charging function (e.g., a wireless power transmission mode or a wireless battery sharing mode) with the second external device 301 during connection to and wired charging of the first external device 201 (e.g., USB charger), or detection of connection to and wired charging of the first external device 201 (e.g., USB charger) during performing of a wireless charging function (e.g., a wireless power transmission mode or a wireless battery sharing mode) with the second external device 301.

The balancing circuit 220 according to the disclosure may control adaptive balancing of the flying capacitor CF without sensing an inductor current IL of the three-level converter 210. The balancing circuit 220 may provide, in the charging circuit 200 and to a control circuit (e.g., an automatic balancing operation switching circuit) for balancing of the flying capacitor CF, seamless switching between an operation corresponding to a buck mode and an operation corresponding to a boost mode, based on path switching in the current mode of the three-level converter 210. The balancing circuit 220 according to the disclosure may include the balancing control circuit (balancing control circuitry) 600 and a switching control circuit (switching control circuitry) 700.

The balancing control circuit 600 according to an embodiment may determine a balancing state caused by a currently configured control direction of the balancing circuit 220 by using a range of the flying capacitor CF without sensing an inductor current IL of the three-level converter 210. In an embodiment, the balancing control circuit 600 may determine whether balancing caused by a current control direction of the balancing circuit 220 is proper, based on whether a designated condition is satisfied by the control direction of the balancing circuit 220. The balancing control circuit 600 may determine whether balancing is maintained at targeted balancing (e.g., the voltage of the flying capacitor CF is maintained at a half voltage Vin/2 of an input voltage Vin), or whether there occurs a difference from the targeted balancing.

When balancing caused by a control direction of the balancing circuit 220 satisfies a designated condition (e.g., current balancing corresponds to targeted balancing), the balancing control circuit 600 may determine that the current control direction is a normal direction (or is proper). As another example, when balancing caused by a control direction of the balancing circuit 220 does not satisfy a designated condition (e.g., there occurs a difference between current balancing and targeted balancing), the balancing control circuit 600 may determine that the current control direction is an error direction (or is improper).

According to an embodiment, the balancing control circuit 600 may generate a control signal (e.g., a gate drive signal) for balancing, based on a change in an output voltage Vo and/or an inductor current IL of both ends of the inductor L. The balancing control circuit 600 may identify whether current balancing caused by a currently configured control direction corresponds to targeted balancing, based on a comparison between the current balancing and the targeted balancing.

In a case where balancing caused by a control direction of the balancing circuit 220 is proper (e.g., the voltage of the flying capacitor CF is maintained at a half voltage Vin/2 of an input voltage Vin), when, for example, current balancing corresponds to targeted balancing, the balancing control circuit 600 may operate to maintain a current configuration (e.g., a control direction or a path). In a case where balancing caused by a control direction of the balancing circuit 220 is improper (e.g., the voltage of the flying capacitor CF is greater or smaller than a half voltage Vin/2 of an input voltage Vin), when, for example, current balancing does not correspond to targeted balancing, the balancing control circuit 600 may operate to toggle (or switch) the control direction (e.g., path) of the balancing circuit 220.

In another embodiment, when the voltage Vc of the flying capacitor CF becomes smaller than ½ of an input voltage Vin in a buck mode, the balancing circuit 220 may operate to gradually increase the duty cycle of the first switching element Q1 and gradually reduce the duty cycle of the second switching element Q2, so as to restore the voltage Vc of the flying capacitor CF to be ½ of the input voltage Vin. When the voltage Vc of the flying capacitor CF becomes greater than ½ of an input voltage Vin in a buck mode, the balancing circuit 220 may operate to gradually reduce the duty cycle of the first switching element Q1 and gradually increase the duty cycle of the second switching element Q2, so as to reduce the voltage Vc of the flying capacitor CF to be ½ of the input voltage Vin.

In yet another embodiment, when the voltage Vc of the flying capacitor CF becomes smaller than ½ of an input voltage Vin in a boost mode, the balancing circuit 220 may operate to gradually reduce the duty cycle of the first switching element Q1 and gradually increase the duty cycle of the second switching element Q2, so as to restore the voltage Vc of the flying capacitor CF to be ½ of the input voltage Vin. When the voltage Vc of the flying capacitor CF becomes greater than ½ of an input voltage Vin in a boost mode, the balancing circuit 220 may operate to gradually increase the duty cycle of the first switching element Q1 and gradually reduce the duty cycle of the second switching element Q2, so as to reduce the voltage Vc of the flying capacitor CF to be ½ of the input voltage Vin. An example of the balancing control circuit 600 for the above description is illustrated in FIG. 6.

In an embodiment, the switching control circuit 700 may generate a control signal (e.g., a gate drive signal) for switching of switching elements (e.g., Q1, Q2, Q3, and Q4) related to balancing of the flying capacitor CF of the three-level converter 210. According to another embodiment, the switching control circuit 700 may control, based on a control signal received from the balancing control circuit 600, switching of switching elements (e.g., Q1, Q2, Q3, and Q4) such that a control direction based on a mode in which the balancing current 220 is currently operating is operated as a first path or a second path reverse to the first path.

According to yet another embodiment, the switching control circuit 700 may obtain a control signal (e.g., a gate drive signal) capable of reversing a control direction of the switching control circuit 700 from the balancing control circuit 600 (e.g., the toggle circuit 620 in FIG. 6). The switching control circuit 700 may perform switching, based on a first control signal (e.g., a signal, for example, “high”, designated to maintain a current configuration) of the balancing control circuit 600, so as to maintain (e.g., maintain the current configuration) a control direction (e.g., a first path) corresponding to a currently designated balancing mode. As another example, the switching control circuit 700 may perform switching, based on a second control signal (e.g., a signal, for example, “low”, designated to change a current configuration) of the balancing control circuit 600, so as to change (e.g., change the first path→a second path to reverse the current configuration) a control direction (e.g., the first path) corresponding to a currently designated balancing mode.

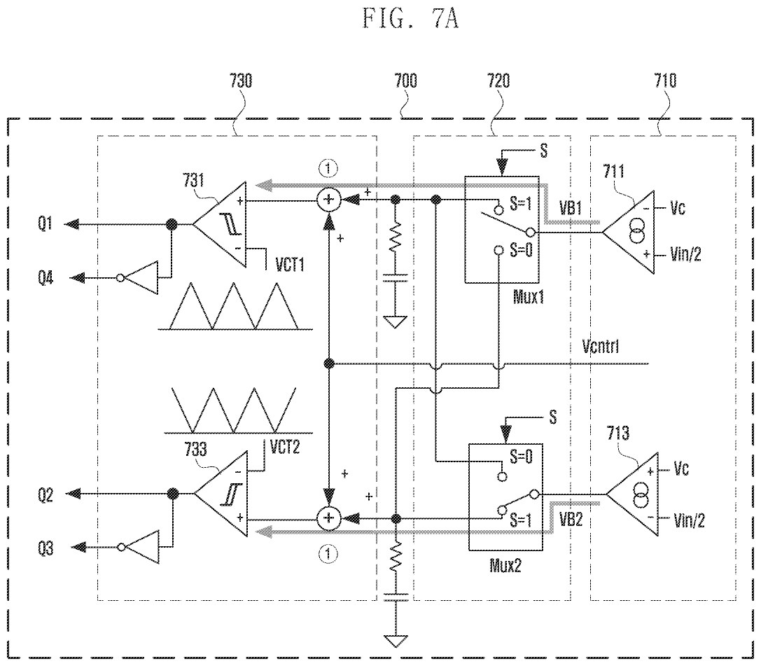

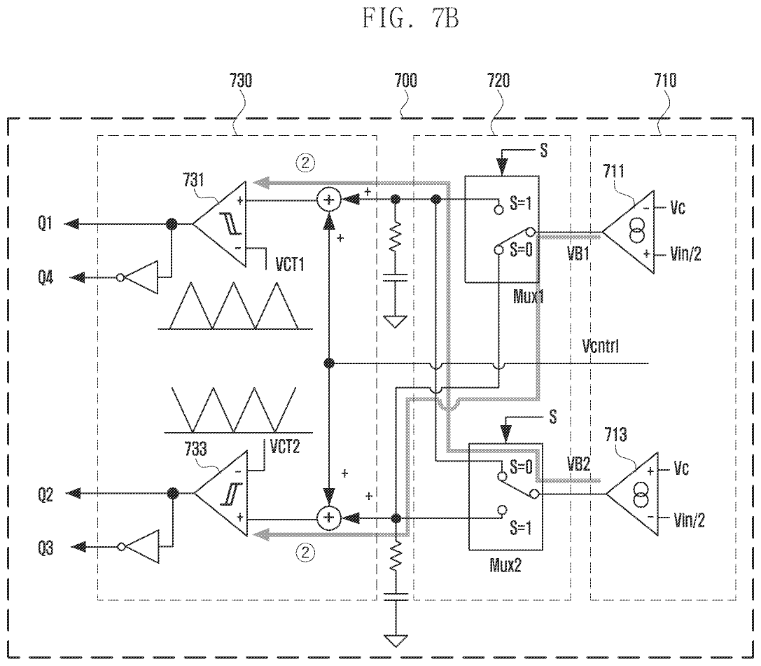

The switching control circuit 700 may control a control direction of the balancing circuit 220 to adaptively switch a mode (e.g., a buck mode or a boost mode) of the three-level converter 210, so as to step-down or step-up the voltage of the flying capacitor CF. An example of the switching control circuit 700 for the above description is illustrated in FIGS. 7A and 7B.

FIG. 6 is a diagram illustrating an example of a circuit configuration of a balancing control circuit in a balancing circuit with regard to FIG. 2 according to an embodiment of the disclosure, and FIGS. 7A and 7B are diagrams illustrating an example of a circuit configuration and an operation of a switching control circuit in the balancing circuit with regard to FIG. 2 according to an embodiment of the disclosure.

In an embodiment, FIG. 6 may show an example of a circuit configuration of the balancing control circuit 600 operating in the balancing circuit 220. In an embodiment, FIGS. 7A and 7B may show an example of a circuit configuration and an operation of the switching control circuit 700 operating in the balancing circuit 220.

Referring to FIGS. 3 and 6, the balancing control circuit 600 may identify current balancing (e.g., a balancing state), based on a half voltage Vin/2 of an input voltage Vin and the voltage Vc of the flying capacitor CF, and output a control signal (e.g., an output signal S of the toggle circuit 620) corresponding to the current balancing. In an embodiment, the balancing control circuit 600 may include a sensing circuit 610 and the toggle circuit 620.

In another embodiment, the sensing circuit 610 may perform a comparison operation for the voltage Vc of the flying capacitor CF and a half voltage Vin/2 of an input voltage Vin, and output a result thereof. In yet another embodiment, the sensing circuit 610 may include at least two comparators and a logic gate (e.g., OR gate).

The sensing circuit 610 may compare the voltage Vc of the flying capacitor CF with a half voltage Vin/2 of an input voltage Vin. The sensing circuit 610 may operate, based on a comparison result, to maintain a current control direction when the voltage Vc of the flying capacitor CF is maintained to be constant almost without a change for a half voltage Vin/2 of an input voltage Vin (e.g., the voltage Vc of the flying capacitor CF is included in a range of a half voltage Vin/2 of an input voltage Vin).

The sensing circuit 610 may operate, based on a comparison result, to transfer a designated output (e.g., a clock signal) to the toggle circuit 620 so as to reverse a current control direction when the voltage Vc of the flying capacitor CF is greater or smaller than a half voltage Vin/2 of an input voltage Vin (e.g., the voltage Vc of the flying capacitor CF is out of a range of a half voltage Vin/2 of an input voltage Vin). According to an embodiment, the sensing circuit 610 may perform a logical operation for two inputs from the two comparators in the logic gate (e.g., OR gate), and may input a clock signal obtained as a result of the logical operation to the toggle circuit 620.

In an embodiment, the toggle circuit 620 may include a flip-flop (F/F) 620. According to an embodiment, the flip-flop (F/F) 620 may include a toggle (T) flip-flop (F/F) (T F/F). According to another embodiment, the toggle circuit 620 may generate an output (S) (e.g., S=high or S=low) of the toggle circuit 620 by using a clock signal of the sensing circuit 610. In an embodiment, the output (S) of the toggle circuit 620 may indicate a control signal (e.g., “H” (High) or “L” (Low)) for selecting a balancing control direction for charging or discharging of the flying capacitor CF.

In yet another embodiment, the toggle circuit 620 may generate an output (S) to reverse a current balancing control direction, based on the input of a clock signal from the sensing circuit 610. The flip-flop 620 may reverse an output (S) (e.g., high or low) every time a clock signal is input from the sensing circuit 610. In an embodiment, the output (S) of the toggle circuit 620 may be input to the switching control circuit 700. According to an embodiment, the toggle circuit 620 may be connected to a reversing circuit 720 (e.g., a multiplexer (mux)) of the switching control circuit 700.

Referring to FIGS. 3, 6, 7A, and 7B, the switching control circuit 700 may generate a control signal (e.g., a gate drive signal) for selecting a balancing control direction of the flying capacitor CF in a buck mode or boost mode, based on the output (S) of the balancing control circuit 600, and input the control signal to the three-level converter 210 (e.g., the switching circuit 310). In an embodiment, the switching control circuit 700 may include a mode determination circuit 710, the reversing circuit 720 (or a compensation circuit), and an operation control circuit 730.

In an embodiment, the mode determination circuit 710 may include two comparators (e.g., a first comparator 711 and a second comparator 713). In another embodiment, each of the comparators 711 and 713 of the mode determination circuit 710 may receive the input of the voltage Vc of the flying capacitor CF and a reference voltage (e.g., a half voltage Vin/2 of an input voltage Vin), and generate a corresponding mode activation signal.

According to yet another embodiment, the mode determination circuit 710 may output mode activation signals (e.g., base voltages VB1 and VB2) for selectively turning on at least some of the multiple switching circuits Q1, Q2, Q3, and Q4 included in the switching circuit 310 of the three-level converter 210 so as to charge or discharge the flying capacitor CF. The mode determination circuit 710 may select a balancing control direction of the flying capacitor CF in a buck mode, or select a balancing control direction of the flying capacitor CF in a boost mode, and output corresponding mode activation signals (e.g., base voltages VB1 and VB2).

In an embodiment, the reversing circuit 720 may include two multiplexers (e.g., a first multiplexer Mux1 and a second multiplexer Mux2). In another embodiment, the reversing circuit 720 may perform switching to bypass or switch a path of mode activation signals (e.g., base voltages VB1 and VB2) of the mode determination circuit 710 (e.g., control the control direction of the mode determination circuit 710 to be reverse) so as to correspond to the balancing control circuit 600 (e.g., the output (S) (e.g., “high” or “low”) of the toggle circuit 620).

According to yet another embodiment, when the output (S) of the toggle circuit 620 is “high” (e.g., S=1), the reversing circuit 720 may operate (e.g., maintain a current control direction) to select a balancing control direction of the flying capacitor CF in a buck mode, as in an example illustrated in FIG. 7A. The reversing circuit 720 may transfer mode activation signals (e.g., base voltages VB1 and VB2) of the mode determination circuit 710 to the operation control circuit 730 through a first path \textcircled{1}.

According to an embodiment, referring to FIG. 7A, the reversing circuit 720 may operate to transfer the first base voltage VB1 of the first comparator 711 and the second base voltage VB2 of the second comparator 713 to the operation control circuit 730 as a part of the input voltage thereof through the first path \textcircled{1} without reversing the path of the voltages. The reversing circuit 720 may operate to input a first control voltage (e.g., Vcntrl1=Vcntrl+VB1) obtained by combination (e.g., sum) of the first base voltage VB1 of the first comparator 711 and a compensation voltage Vcntrl, to a first selector 731 of the operation control circuit 730 according to the first path \textcircled{1}. In addition, the reversing circuit 720 may operate to input a second control voltage (e.g., Vcntrl2=Vcntrl+VB2) obtained by combination (e.g., sum) of the second base voltage VB2 of the second comparator 713 and a compensation voltage Vcntrl, to a second selector 733 of the operation control circuit 730 according to the first path \textcircled{1}.

According to another embodiment, when the voltage Vc of the flying capacitor CF becomes smaller than ½ of an input voltage Vin in the current mode, the balancing circuit 220 may operate to gradually increase the duty cycle of the first switching element Q1 and gradually reduce the duty cycle of the second switching element Q2 according to the first path \textcircled{1}, so as to restore (e.g., perform balancing compensation) the voltage Vc of the flying capacitor CF to be ½ of the input voltage Vin.

As another example, when the voltage Vc of the flying capacitor CF becomes greater than ½ of an input voltage Vin in the current mode, the balancing circuit 220 may operate to gradually reduce the duty cycle of the first switching element Q1 and gradually increase the duty cycle of the second switching element Q2 according to the first path \textcircled{1}, so as to reduce (e.g., perform balancing compensation) the voltage Vc of the flying capacitor CF to be ½ of the input voltage Vin.

According to yet another embodiment, when the output (S) of the toggle circuit 620 is “low” (e.g., S=0), the reversing circuit 720 may operate (e.g., reverse a current control direction) to select a balancing control direction of the flying capacitor CF in a boost mode, as in an example illustrated in FIG. 7B. The reversing circuit 720 may transfer mode activation signals (e.g., base voltages VB1 and VB2) of the mode determination circuit 710 to the operation control circuit 730 through a second path \textcircled{2}.

According to an embodiment, referring to FIG. 7B, the reversing circuit 720 may operate to switch (or reverse) a path (e.g., the first path \textcircled{1}) of the first base voltage VB1 of the first comparator 711 and the second base voltage VB2 of the second comparator 713, and transfer the voltages to the operation control circuit 730 as a part of the input voltage thereof through the second path \textcircled{2}. The reversing circuit 720 may operate to input the first control voltage (e.g., Vcntrl1=Vcntrl+VB1) obtained by combination (e.g., sum) of the first base voltage VB1 of the first comparator 711 and a compensation voltage Vcntrl, to the second selector 733 of the operation control circuit 730 according to the second path \textcircled{2}.

In addition, the reversing circuit 720 may operate to input the second control voltage (e.g., Vcntrl2=Vcntrl+VB2) obtained by combination (e.g., sum) of the second base voltage VB2 of the second comparator 713 and a compensation voltage Vcntrl, to the first selector 731 of the operation control circuit 730 according to the second path \textcircled{2}.

According to another embodiment, when the voltage Vc of the flying capacitor CF becomes smaller than ½ of an input voltage Vin in the current mode, the balancing circuit 220 may operate to gradually reduce the duty cycle of the first switching element Q1 and gradually increase the duty cycle of the second switching element Q2 according to the second path \textcircled{2} having a reversed polarity, so as to restore (e.g., perform balancing compensation) the voltage Vc of the flying capacitor CF to be ½ of the input voltage Vin. As another example, when the voltage Vc of the flying capacitor CF becomes greater than ½ of an input voltage Vin in the current mode, the balancing circuit 220 may operate to gradually increase the duty cycle of the first switching element Q1 and gradually reduce the duty cycle of the second switching element Q2 according to the second path \textcircled{2} having a reversed polarity for balancing compensation, so as to reduce (e.g., perform balancing compensation) the voltage Vc of the flying capacitor CF to be ½ of the input voltage Vin.

According to yet another embodiment, when the output (S) of the toggle circuit 620 is switched to “high” (e.g., S=1) during an operation corresponding to a balancing control direction of the flying capacitor CF in a boost mode as in an example illustrated in FIG. 7B, the reversing circuit 720 may operate (e.g., reverse a current control direction) to select a balancing control direction of the flying capacitor CF in a buck mode, as in an example illustrated in FIG. 7A.

According to an embodiment, when the output (S) of the toggle circuit 620 (e.g., flip-flop) is “high”, a balancing control direction (e.g., the first path \textcircled{1}) of the flying capacitor CF in a buck mode may be selected for the three-level converter 210. When the output (S) of the toggle circuit 620 is “high”, the reversing circuit 720 may perform switching such that the output of the first multiplexer Mux1 is connected to the first selector 731 of the operation control circuit 730, and the output of the second multiplexer Mux2 is connected to the second selector 733 of the operation control circuit 730.

According to another embodiment, when the output (S) of the toggle circuit 620 (e.g., flip-flop) is “low”, a balancing control direction of the flying capacitor CF in a boost mode may be selected for the three-level converter 210. When the output (S) of the toggle circuit 620 is “low”, the reversing circuit 720 may perform switching such that the output of the first multiplexer Mux1 is connected to the second selector 731 of the operation control circuit 730, and the output of the second multiplexer Mux2 is connected to the first selector 733 of the operation control circuit 730.

In yet another embodiment, the operation control circuit 730 may generate a control signal (e.g., a gate drive signal) related to switching of the switching circuit 310 of the three-level converter 210, based on signals (e.g., the first control voltage Vcntrl1 and the second control voltage Vcntrl2) input via the mode determination unit 710 and the reversing circuit 720. According to an embodiment, the operation control circuit 730 may generate a control signal for charging or discharging of the flying capacitor CF by selectively turning on at least some of the multiple switching elements Q1, Q2, Q3, and Q4 so as to correspond to a control direction of the mode determination circuit 710 and the reversing circuit 720, determined via the reversing circuit 720.

The switching control circuit 700 may obtain control signals for the two multiplexers Mux land Mux2, which are capable of reversing a control direction of the switching control circuit 700, from the toggle circuit 620 of the balancing control circuit 600.

In an embodiment, when the output (S) of the toggle circuit 620 is “high”, a balancing control direction of the flying capacitor CF in a buck mode may be selected for the switching control circuit 700. When the voltage Vc of the flying capacitor CF drops to be equal to or smaller than a half of an input voltage Vin (e.g., reduction in Q1 duty, and increase in Q2 duty), the switching control circuit may generate gate drive signals (e.g., Q1 ON and Q2 OFF (Q3 ON and Q4 OFF)) of the first selector 731 and the second selector 733 so that the duty cycle of the first switching element Q1 is gradually increased and the duty cycle of the second switching element Q2 is gradually reduced so as to restore the voltage Vc of the flying capacitor CF to be ½ of the input voltage Vin.

In another embodiment, when the output (S) of the toggle circuit 620 is “low”, a balancing control direction of the flying capacitor CF in a boost mode may be selected for the switching control circuit 700. When the voltage Vc of the flying capacitor CF drops to be equal to or smaller than a half of an input voltage Vin (e.g., increase in Q1 duty, and reduction in Q2 duty), the switching control circuit may generate gate drive signals (e.g., Q1 OFF and Q2 ON (Q3 OFF and Q4 ON)) of the first selector 731 and the second selector 733 so that the duty cycle of the first switching element Q1 is gradually reduced and the duty cycle of the second switching element Q2 is gradually increased so as to restore the voltage Vc of the flying capacitor CF to be ½ of the input voltage Vin. In yet another embodiment, the operation control circuit 730 may generate control signals allowing the first switching element Q1 and the second switching element Q2 to have a 180-degree phase difference therebetween.

In the above description, as discussed with reference with FIG. 3 to FIG. 7B, the balancing circuit 220 according to the disclosure may include the switching control circuit 700 capable of reversing (e.g., switching between a buck mode or a boost mode) a balancing control direction of the flying capacitor CF, and the balancing control circuit 600 for control of the output of the switching control circuit 700. According to an embodiment, the switching control circuit 700 may include two multiplexers (e.g., the first multiplexer Mux1 and the second multiplexer Mux2), and the balancing control circuit 600 may include the toggle circuit 620 (e.g., toggle flip-flop) for control of the output of the reversing circuit 720 (e.g., two multiplexers Mux1 and Mux2). According to an embodiment, a control signal for control of the output of the reversing circuit 720 may be provided to each of the two multiplexers Mux1 and Mux2 of the reversing circuit 720 via the toggle circuit 620 (e.g., toggle flip-flop).

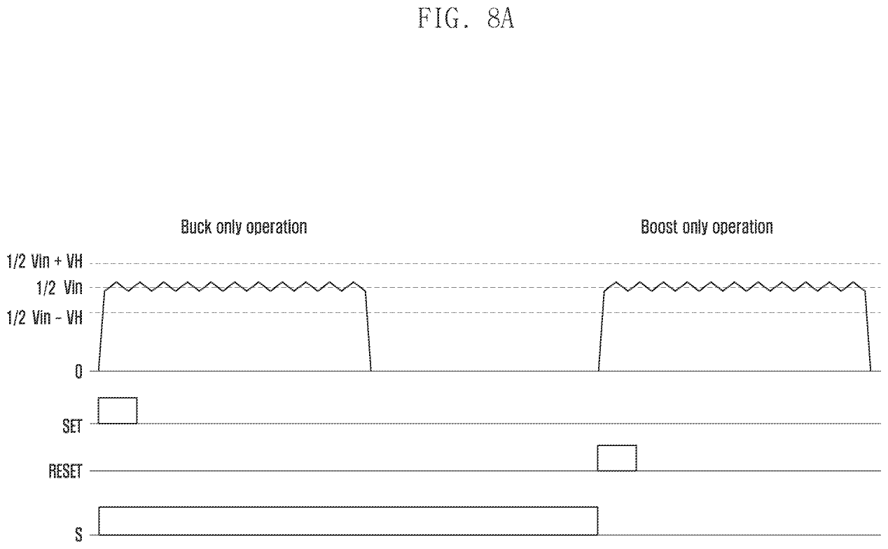

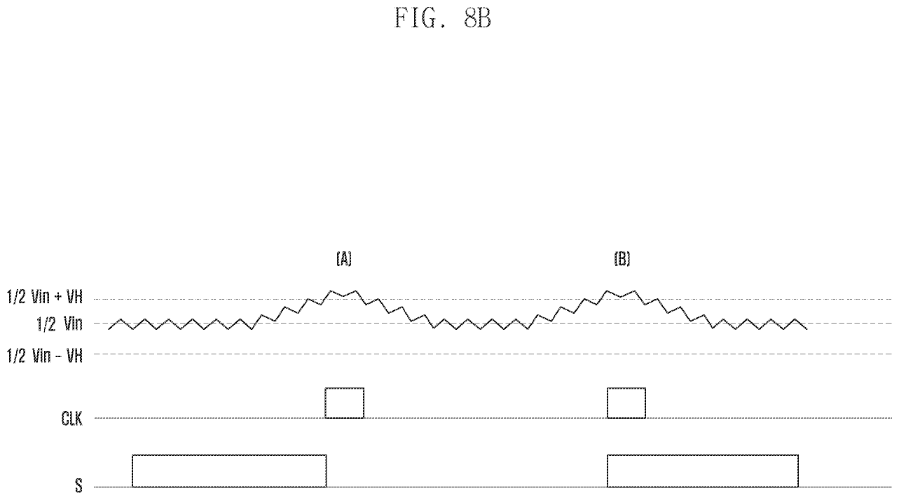

According to an embodiment, a basic output of the toggle circuit 620 may be determined, for example, by the processor 120 to be a value corresponding to an initial operation mode configuration of the charging circuit 200. An initial operation mode may be configured to be a first set (e.g., buck setting) or a second set (reset) (e.g., boost setting). According to the disclosure, when the voltage Vc of the flying capacitor CF becomes greater or smaller than a half voltage Vin/2 of an input voltage Vin by a designated reference voltage VH because the balancing circuit 220 fails to operate properly according to a selected mode during a charging operation corresponding to an initial operation mode configuration, the voltage balancing of the flying capacitor CF may be corrected by a normal operation of the balancing circuit 220 through forcible switching of the selected mode. An example therefor is illustrated in FIGS. 8A and 8B.

FIGS. 8A and 8B are diagrams illustrating a balancing control operation of an electronic device according to various embodiment of the disclosure.

FIG. 8A may show an example of an operation in a state where, for example, a buck mode or a boost mode is clearly designated by the processor 120. The diagram may show a state where the charging circuit 200 operates in an operation mode thereof, which is configured by the processor 120 to be set (e.g., buck setting) or reset (e.g., boost setting). Regardless of whether a clock signal is input to the toggle circuit 620, the output (S) may be determined to be “high” or “low” according to a designated operation mode. The state may be a state in which a range of the flying capacitor CF is maintained to be constant within a designated hysteresis (e.g., +VH and −VH) range in consideration of ripple with respect to a center value (e.g., Vin/2).

FIG. 8B may show a state where, for example, during operation as in FIG. 8A, as in examples illustrated in FIGS. 4 and 5, in a complex environment of input and output bi-directional operation for charging, a buck mode and a boost mode are frequently alternated, or are not clearly determined due to ping-pong of a current direction around “0”. The diagram may show an example of a state in which a range of the flying capacitor CF falls out of a designated hysteresis (e.g., +VH and −VH) range with respect to a center value (e.g., Vin/2).

The diagram may show an example of occurrence of a case where the voltage of the flying capacitor CF is greater or smaller than a half voltage Vin/2 of an input voltage Vin. It is considered that balancing caused by a current operation mode (e.g., buck mode or boost mode) fails, and a clock may be generated for the toggle circuit 620 in an (A) interval in which the range of the flying capacitor CF is out of a designated range (e.g., Vin/2+VH or Vin/2−VH).

According to an embodiment, during an operation in a buck mode at “high” as the output (S) of the toggle circuit 620, in response to a clock generation in the (A) interval, the output S may be reversed from “high” to “low”, and the mode may be switched to a boost mode for operation according to “low” as the output (S). The outputs of multiplexers (e.g., multiplexers Mux1 and Mux2) of the reversing circuit 720 may cross each other to be output to the operation control circuit 730 (e.g., the second path \textcircled{2} in FIG. 7B), so as to switch a balancing control direction of the flying capacitor CF. According to another embodiment, during an operation in a boost mode at “low” as the output (S) of the toggle circuit 620, in response to a clock generation in an (B) interval, the output S may be reversed from “low” to “high”, and the mode may be switched to a buck mode for operation according to “high” as the output (S). The outputs of multiplexers (e.g., multiplexers Mux1 and Mux2) of the reversing circuit 720 may be directly output to the operation control circuit 730 (e.g., the first path \textcircled{1} in FIG. 7A), so as to switch a balancing control direction of the flying capacitor CF.

According to the disclosure, when a designated range for the flying capacitor CF is configured, and the flying capacitor CF is within the designated range, an operation may be performed to maintain a currently configured control direction of the balancing circuit 220. When the flying capacitor is out of the designated range, an operation may be performed to generate clock so as to adaptively switch the control direction of the balancing circuit 220. When the voltage Vc of the flying capacitor CF is greater or smaller than a half voltage Vin/2 of an input voltage Vin, a duration of “high” or “low” as the output (S) of the toggle circuit 620 may be adaptively changed so that an operation in a buck mode and an operation in a boost mode may be switched seamlessly.

As in examples illustrated in FIGS. 8A and 8B, the output (S) of the toggle circuit 620 may be determined by a value corresponding to an initial operation mode configuration. However, when the voltage Vc of the flying capacitor CF becomes greater or smaller than a half Vin/2 (e.g., center value) of an input voltage Vin by a hysteresis VH because voltage balancing of the balancing circuit 220 according to a selected mode, the voltage balancing of the flying capacitor CF may be corrected through forcible switching of the selected mode.

As discussed above, according to the disclosure, in an environment of input and output bi-directional operation for charging, even when the power of an external power source is insufficient, a buck mode and a boost mode of the three-level converter 210 may be naturally and seamlessly switched therebetween (a balancing control direction of the flying capacitor CF may be switched).

The electronic device 101 according to an embodiment of the disclosure may include the battery 189, the processor 120, and the charging circuit 200. The charging circuit 200 may include, as the three-level converter 210 which has one end connecting a charging path with at least one external device, and a remaining end connecting a charging path with the battery, and is configured to perform a bi-directional operation including input and/or output related to a charging operation with the at least one external device, the switching circuit 310 including the multiple switching elements Q1, Q2, Q3, and Q4 and the flying capacitor CF, and the filter circuit 320 including the inductor L and the capacitor Co. The charging circuit 200 may include, as the balancing circuit 220 configured to balance voltage of the flying capacitor CF of the three-level converter 210, the balancing control circuit 600 configured to, during balancing corresponding to a designated a mode designated by the processor 120 as an initial operation mode, based on whether the balancing corresponds to targeted balancing, generate an output for maintaining or switching a balancing control direction configured for the designated mode, and the switching control circuit 700 configured to perform switching for the switching elements in a balancing control direction corresponding to the designated mode, based on an output of the balancing control circuit, or perform switching for the switching elements in a direction reverse to a balancing control direction corresponding to the designated mode.

The balancing control circuit 600 according to another embodiment may be configured to control switching between a buck mode and a boost mode of the three-level converter 210 in a wired and wireless complex operation condition of the electronic device 101, the buck mode may include a mode of decreasing an input voltage and outputting the decreased input voltage, and the boost mode may include a mode of increasing an input voltage and outputting the increased input voltage.

The balancing control circuit 600 according to yet another embodiment may operate to generate a control signal for maintaining a first path configured for the designated mode when the balancing corresponds to the targeted balancing.

The balancing control circuit 600 according to an embodiment may operate to, when the balancing does not correspond to the targeted balancing, generate a control signal for switching the first path configured for the designated mode to a second path opposite to the first path, and a control signal for switching to the second path may include a reverse signal of a control signal for maintaining the first path.

The switching control circuit 700 according to another embodiment may include the reversing circuit 720 configured to reverse a control direction of the balancing circuit 220.

The reversing circuit 720 according to yet another embodiment may include two multiplexers configured to control a control direction of the balancing circuit 220 to be reversed.

The balancing control circuit 600 according to an embodiment may include the toggle circuit 620 configured to control operations of the two multiplexers.

The balancing control circuit 600 according to another embodiment may operate to, when a designated condition is not satisfied by a control direction of the balancing circuit 200, change a control direction of the switching control circuit 700 via the toggle circuit 620.

The reversing circuit 720 according to yet another embodiment may control the switching control circuit 700 to select a balancing control direction of the flying capacitor CF in a buck mode when an output of the toggle circuit 620 is high (H).

The reversing circuit 720 according to an embodiment may control the switching control circuit 700 to select a balancing control direction of the flying capacitor CF in a boost mode when an output of the toggle circuit 620 is low (L).

For the balancing control circuit 600 according to another embodiment, configuration of an initial operation mode related to an output of the toggle circuit 620 may be determined by the processor 120.

The balancing control circuit 600 according to yet another embodiment may operate to, when a voltage of the flying capacitor becomes greater or smaller than a half voltage of an input voltage by a reference voltage due to balancing based on the initial operation mode, generate a corresponding control signal to forcibly switch the initial operation mode.

The charging circuit 200 according to an embodiment may operate to, in a wired and wireless complex operation condition of the electronic device 101, regardless of the designated mode for voltage balancing of the flying capacitor CF, automatically select a balancing control direction, based on a state of current balancing.

The balancing control circuit 600 according to another embodiment may operate to determine a state of a currently configured balancing control direction of the balancing circuit 220 by using a range of the flying capacitor CF without sensing of an inductor current IL of the three-level converter 210.

The processor 120 according to yet another embodiment may operate to, when the electronic device 101 performs a charging function with at least one external device 201 and 301, configure an initial operation mode to be the designated mode corresponding to the charging function with respect to an output of the balancing control circuit 600.

The balancing circuit 220 according to an embodiment may operate to selectively turn on at least some of the multiple switching elements so as to control charging or discharging of the flying capacitor CF.

The charging circuit 200 of the electronic device 101 according to another embodiment of the disclosure may include the three-level converter 210 and the balancing circuit 220, wherein the three-level converter 210 has one end connecting a charging path with at least one external device, and a remaining end connecting a charging path with the battery, is configured to perform a bi-directional operation including input and/or output related to a charging operation with the at least one external device, and includes the switching circuit 310 including the multiple switching elements Q1, Q2, Q3, and Q4 and the flying capacitor CF, and the filter circuit 320 including the inductor L and the capacitor Co, wherein the balancing circuit 220 is configured to balance voltage of the flying capacitor CF of the three-level converter 210, and includes the balancing control circuit 600 configured to, during balancing corresponding to a designated mode, based on whether the balancing corresponds to targeted balancing, generate a first control signal for maintaining a first path configured for the designated mode, or a second control signal for switching the first path configured for the designated mode to a second path, and the switching control circuit 700 configured to perform switching for the switching elements in a balancing control direction corresponding to the designated mode, based on input of the first control signal, or perform switching for the switching elements in a direction reverse to a balancing control direction corresponding to the designated mode, based on input of the second control signal, and wherein the second control signal is a signal obtained by reversing the first control signal.

The balancing control circuit 600 according to yet another embodiment may operate to control switching between a buck mode and a boost mode of the three-level converter 210 in a wired and wireless complex operation condition of the electronic device 101.

The switching control circuit 700 according to an embodiment may include two multiplexers configured to control a control direction of the balancing circuit 220 to be reversed, and the balancing control circuit 600 may include the toggle circuit 620 configured to control operations of the two multiplexers.

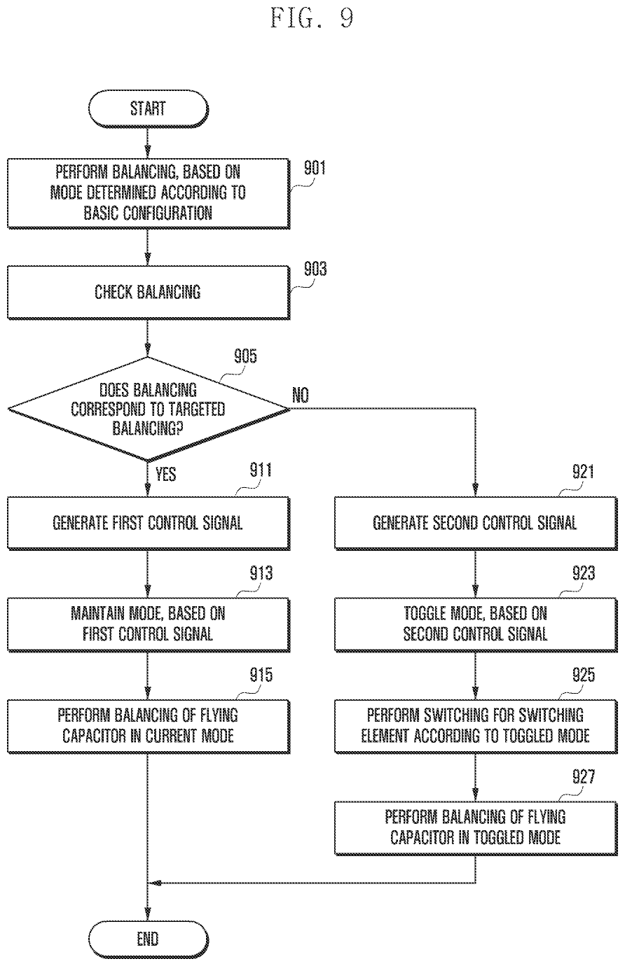

FIG. 9 is a flowchart illustrating an operation method for supporting charging by an electronic device according to an embodiment of the disclosure.

In an embodiment, the operation method in FIG. 9 may be performed by the charging circuit 200 of the electronic device 101.

Referring to FIG. 9, in operation 901, the electronic device 101 may perform balancing, based on a mode determined according to a basic configuration. According to an embodiment, the electronic device 101 may be connected to at least one external device (e.g., the first external device 201 and/or the second external device 301) by wire and/or wirelessly, and may initiate a charging operation with the at least one connected external device.

According to another embodiment, the electronic device 101 may perform balancing according to a designated balancing mode in a complex operation condition related to wired and wireless charging with the at least one external device. The electronic device 101 may perform balancing, based on a balancing control direction corresponding to a designated mode (e.g., a buck mode or a boost mode) in the charging circuit 200 capable of a bi-directional operation using the three-level converter 210.

In yet another embodiment, the complex operation condition may include, for example, various complex environments, such as detection of connection to the first external device 201 (e.g., OTG device) while the electronic device 101 performs a wireless charging function (e.g., a wireless power reception mode) with the second external device 301, detection of connection to and performing a wireless charging function (wireless power reception mode) with the second external device 301 during connection to the first external device 201 (e.g., OTG device), detection of performing a wireless charging function (e.g., a wireless power transmission mode or a wireless battery sharing mode) with the second external device 301 during connection to and wired charging of the first external device 201 (e.g., USB charger), or detection of connection to and wired charging of the first external device 201 (e.g., USB charger) during performing of a wireless charging function (e.g., a wireless power transmission mode or a wireless battery sharing mode) with the second external device 301.

In operation 903, the electronic device 101 may check the balancing. According to an embodiment, the electronic device 101 may check current balancing, based on a result of a comparison operation for a first input voltage (e.g., the voltage Vc of the flying capacitor CF and a second input voltage (e.g., a half voltage Vin/2 of an input voltage) via the balancing circuit 220 during the balancing.

In operation 905, the electronic device 101 may determine whether the current balancing corresponds to targeted balancing. According to an embodiment, the electronic device 101 may determine a difference between the first input voltage and the second input voltage, based on the result of the comparison operation of the balancing circuit 220. The electronic device 101 may determine a range of the flying capacitor CF, based on the half voltage Vin/2 of the input voltage Vin, and determine whether a currently configured balancing control direction for balancing is proper, based on the range of the flying capacitor CF. The electronic device may identify whether the voltage Vc of the flying capacitor CF according to the current balancing shows a result (e.g., target voltage) corresponding to targeted balancing.

When the current balancing corresponds to the targeted balancing in operation 905, the electronic device 101 may generate a corresponding control signal (e.g., output (S)) in operation 911. The electronic device 101 may generate a control signal enabling maintenance of a balancing control direction corresponding to the current balancing via the balancing circuit 220. In a case of a balancing control direction of the flying capacitor CF in a buck mode according to a basic configuration, the electronic device 101 may generate a control signal to maintain the buck mode. As another example, in a case of a balancing control direction of the flying capacitor CF in a boost mode according to a basic configuration, the electronic device 101 may generate a control signal to maintain the boost mode.

In operation 913, the electronic device 101 may maintain a current mode (e.g., buck mode or boost mode), based on the control signal. According to an embodiment, the electronic device 101 may maintain a current mode (e.g., buck mode or boost mode) according to a basic configuration without switching a control direction of the balancing circuit 220.

In operation 915, the electronic device 101 may continue balancing the flying capacitor CF in the current mode. According to an embodiment, the electronic device 101 may continue balancing the flying capacitor CF in a buck mode or a boost mode according to a basic configuration.

When the current balancing does not correspond to the targeted balancing in operation 905, the electronic device 101 may reverse a control signal in operation 921. The electronic device 101 may generate a reversed control signal to reverse a balancing control direction corresponding to the current balancing via the balancing circuit 220. The control signal may be a reverse signal for controlling a balancing control direction to be reversed. In a case of a balancing control direction of the flying capacitor CF in a buck mode according to a basic configuration, the electronic device 101 may generate a control signal (e.g., a reverse signal) to switch the buck mode to a boost mode. As another example, in a case of a balancing control direction of the flying capacitor CF in a boost mode according to a basic configuration, the electronic device 101 may generate a control signal (e.g., a reverse signal) to switch the boost mode to a buck mode.

In operation 923, the electronic device 101 may switch (or toggle) a current mode (e.g., buck mode or boost mode) to a different mode (e.g., boost mode or buck mode), based on the control signal. According to an embodiment, the electronic device 101 may switch a control direction of the balancing circuit 220 so as to forcibly switch a currently selected mode (e.g., buck mode or boost mode) according to a basic configuration.

In operation 925, the electronic device 101 may perform switching (e.g., selective turning-on) for at least some of the switching elements Q1, Q2, Q3, and Q4 of the switching circuit 310 according to the switched mode.

In operation 927, the electronic device 101 may perform balancing of the flying capacitor CF in the switched mode. According to an embodiment, the electronic device 101 may reversely toggle a control direction of the flying capacitor CF according to a buck mode or boost mode determined by a basic configuration, and may perform balancing of the flying capacitor CF in a balancing control direction of the flying capacitor CF corresponding to the toggled mode.

As described above, according to the disclosure, the electronic device 101 may, based on whether balancing based on a currently selected mode corresponds to targeted balancing, may maintain a first path configured in the currently selected mode (e.g., a buck mode or a boost mode), or toggle (or reverse) the first path configured in the currently selected mode to a second path opposite to the first path.

According to an embodiment, the electronic device 101 may determine whether current balancing is proper, regardless of a designated mode (e.g., a buck mode or a boost mode) for the voltage of the flying capacitor CF in the charging circuit 200 capable of a bi-directional operation using the three-level converter 210, and may automatically select a balancing mode (or path) suitable for the current balancing, based on the result thereof, and switch to the selected mode. The electronic device 101 according to the disclosure may support adaptive switching between a buck mode and a boost mode of the three-level converter 210 without disconnection of the input power of the charging circuit 200 in a complex operation condition in which the electronic device performs wired and wireless charging.

An operation method performed by the electronic device 101 according to an embodiment of the disclosure may include performing balancing in a complex operation condition related to wired and wireless charging with at least one external device, based on a mode determined according to a basic configuration, while performing the balancing, checking a balancing state to determine whether the balancing corresponds to targeted balancing, when the balancing corresponds to targeted balancing, generate a first control signal to maintain a balancing control direction corresponding to the balancing, when the balancing does not correspond to targeted balancing, generate a second control signal obtained by reversing the first control signal, so as to reverse a balancing control direction corresponding to the balancing, performing selective switching for at least some of multiple switching elements so as to switch the determined mode corresponding to the basic configuration, and performing balancing of a flying capacitor in the switched mode.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a battery;
at least one processor; and
a charging circuit,
wherein the charging circuit is configured to comprise a three-level converter and a balancing circuit,
wherein the three-level converter has one end connecting a charging path with at least one external device, and a remaining end connecting a charging path with the battery, is configured to perform a bi-directional operation including input and/or output related to a charging operation with the at least one external device, and comprises:
a switching circuit including multiple switching elements and a flying capacitor, and
a filter circuit including an inductor and a capacitor, and
wherein the balancing circuit is configured to balance voltage of the flying capacitor of the three-level converter, and comprises:
a balancing control circuit configured to, during balancing corresponding to a mode designated by the at least one processor as an initial operation mode, based on whether the balancing corresponds to targeted balancing, generate an output for maintaining or switching a balancing control direction configured for the designated mode, and
a switching control circuit configured to perform switching for the switching elements in a balancing control direction corresponding to the designated mode, based on an output of the balancing control circuit, or perform switching for the switching elements in a direction reverse to a balancing control direction corresponding to the designated mode.

2. The electronic device of claim 1,
wherein the balancing control circuit is further configured to control switching between a buck mode and a boost mode of the three-level converter in a wired and wireless complex operation condition of the electronic device,
wherein the buck mode comprises a mode of decreasing an input voltage and outputting the decreased input voltage, and
wherein the boost mode comprises a mode of increasing an input voltage and outputting the increased input voltage.

3. The electronic device of claim 2,
wherein the balancing control circuit is further configured to:
when the balancing corresponds to the targeted balancing, generate a control signal for maintaining a first path configured for the designated mode, and
when the balancing does not correspond to the targeted balancing,
generate a control signal for switching the first path configured for the designated mode to a second path opposite to the first path, and
wherein a control signal for switching to the second path is a reverse signal of a control signal for maintaining the first path.

4. The electronic device of claim 1, wherein the switching control circuit comprises a reversing circuit configured to reverse a control direction of the balancing circuit.

5. The electronic device of claim 4, wherein the reversing circuit comprises two multiplexers configured to control a control direction of the balancing circuit to be reversed.

6. The electronic device of claim 5, wherein the balancing control circuit comprises a toggle circuit configured to control operations of the two multiplexers.

7. The electronic device of claim 6, wherein the balancing control circuit is further configured to, when a designated condition is not satisfied by a control direction of the balancing circuit, change a control direction of the switching control circuit via the toggle circuit.

8. The electronic device of claim 7, wherein the reversing circuit is further configured to:
when an output of the toggle circuit is high (H), control the switching control circuit to select a balancing control direction of the flying capacitor in a buck mode; and
when an output of the toggle circuit is low (L), control the switching control circuit to select a balancing control direction of the flying capacitor in a boost mode.

9. The electronic device of claim 6,
wherein, for the balancing control circuit, configuration of an initial operation mode related to an output of the toggle circuit is determined by the at least one processor, and
wherein the balancing control circuit is further configured to generate a corresponding control signal to forcibly switch the initial operation mode when voltage of the flying capacitor becomes greater or smaller than a half voltage of an input voltage by a reference voltage due to balancing based on the initial operation mode.

10. The electronic device of claim 1, wherein the charging circuit is further configured to, in a wired and wireless complex operation condition of the electronic device, regardless of the designated mode for voltage balancing of the flying capacitor, automatically select a balancing control direction, based on a state of current balancing.

11. The electronic device of claim 10, wherein the balancing control circuit is further configured to determine a state of a currently configured balancing control direction of the balancing circuit by using a range of the flying capacitor without sensing of an inductor current of the three-level converter.

12. The electronic device of claim 1, wherein the at least one processor is further configured to, when the electronic device performs a charging function with at least one external device, configure an initial operation mode to be the designated mode corresponding to the charging function with respect to an output of the balancing control circuit.

13. The electronic device of claim 1, wherein the balancing circuit is further configured to selectively turn on at least some of the multiple switching elements so as to control charging or discharging of the flying capacitor.

14. A charging circuit comprising:
a three-level converter and a balancing circuit,
wherein the three-level converter has one end connecting a charging path with at least one external device, and a remaining end connecting a charging path with a battery, is configured to perform a bi-directional operation including input and/or output related to a charging operation with the at least one external device, and comprises:
a switching circuit including multiple switching elements and a flying capacitor, and
a filter circuit including an inductor and a capacitor,
wherein the balancing circuit is configured to balance voltage of the flying capacitor of the three-level converter, and comprises:
a balancing control circuit configured to, during balancing corresponding to a designated mode, based on whether the balancing corresponds to targeted balancing, generate a first control signal for maintaining a first path configured for the designated mode, or a second control signal for switching the first path configured for the designated mode to a second path, and
a switching control circuit configured to perform switching for the switching elements in a balancing control direction corresponding to the designated mode, based on input of the first control signal, or perform switching for the switching elements in a direction reverse to a balancing control direction corresponding to the designated mode, based on input of the second control signal, and
wherein the second control signal is a signal obtained by reversing the first control signal.

15. The charging circuit of claim 14,
wherein the balancing control circuit is further configured to control switching between a buck mode and a boost mode of the three-level converter in a wired and wireless complex operation condition of the electronic device, and
wherein the switching control circuit comprises two multiplexers configured to control a control direction of the balancing circuit to be reversed.

16. A method of operating an electronic device, the method comprising:
performing balancing in a complex operation condition related to wired and wireless charging with at least one external device, based on a mode determined according to a basic configuration;
while the performing of the balancing, checking a balancing state to determine whether the balancing corresponds to targeted balancing;
when the balancing corresponds to targeted balancing, generating a first control signal to maintain a balancing control direction corresponding to the balancing;
when the balancing does not correspond to targeted balancing, generating a second control signal obtained by reversing the first control signal, so as to reverse a balancing control direction corresponding to the balancing;
performing selective switching for at least some of multiple switching elements so as to switch the determined mode corresponding to the basic configuration; and
performing balancing of a flying capacitor in the switched mode.

17. The method of claim 16, wherein the target balancing is based on a voltage of the flying capacitor being maintained at a half voltage of an input voltage.

18. The method of claim 16, further comprising:
detecting the complex operation condition based on detecting a connection to a first external device while performing a wireless charging function with a second external device.

19. The method of claim 16, further comprising:
detecting the complex operation condition based on detecting a connection to and performing a wireless charging function with a second external device during connection to a first external device.

20. The method of claim 16, further comprising:
adaptive balancing of the flying capacitor without sensing an inductor current of a three-level converter.
